(19) United States
(12) Patent Application Publication
(10) Pub. No.: US 2008/0224367 A1
(43) Pub. Date: Sep. 18, 2008

(54) Pit Furnace Closing System

(76) Inventors: Rodolfo Napoli, San Paulo (BR); Massaco Simoyama Napoli, San Paulo (BR)

Correspondence Address: ROSENBERG, KLEIN & LEE, 3458 ELLICOTT CENTER DRIVE-SUITE 101, ELLICOTT CITY, MD, 21043, US

(21) Appl. No.: 10/587,851

(22) PCT Filed: Jan. 21, 2005
(86) PCT No.: PCT/BR2005/000007

§ 371 Date: Jul. 28, 2006

(30) Foreign Application Priority Data
Jan. 30, 2004 (BR) PI 0400619-4
Apr. 26, 2004 (BR) CI 0400619-4

(51) Int. Cl. F27B 13/06

(52) U.S. Cl. 266/272

(57) ABSTRACT

“PIT FURNACE CLOSING SYSTEM” comprising the use of two beams and several square iron bars laid across the border of the furnace and supported over said beams, and pieces of cloth wrap for high temperature are used for closing the furnace or a species box in a stainless steel screen was further developed, folded and having a ring, and filled in with remains of wraps, or even a biparted lid in a thin plate with wraps fixed to it and a cut for the upper part of the supporting device of the parts to pass, which is the “cage”-like one, and suspended inside the furnace and supported in the two beams, not resting on the floor of the furnace, and said furnace has thermopairs, which may be in contact with the part entering into the mouth of the furnace, or may be loosen ones, and their heating ends are located in the central direction of each heating zone (thermopairs bar), and for having a variant foreseen with oil heating and having a rectangular format, which is coated with refractory bricks fixed with stainless steel pins. An end of the pin is welded in the plate of the furnace and the other part is welded in a square plate, which may contain a possible movimentation of the vertical walls of the furnace, and the burners may be fed with diesel oil or with viscous fuel oil.

The present Invention Patent of Pit Furnace Closing System, with innovative conception and having important technological and functional improvements, in accordance with the most modern concepts of engineering and in conformity with the required rules and specifications, and which mainly differs from the other lid systems used in the conventional furnaces, so as to provide series of technical advantages, both practical and economical, having its features the novelty fundamental requirements.

The pit furnace consists of, in general, a tubular structure in the internal part of which the parts to be submitted to the high temperature are placed, in suspension and through convenient supports, for the purposes of tempera.

In the conventional system, the parts are always supported or hung in a device having the shape of a basket, or similar to a tree, with a central axis having several beams, being said parts hung in these beams. This basket or tree may be supported in the floor of the furnace.

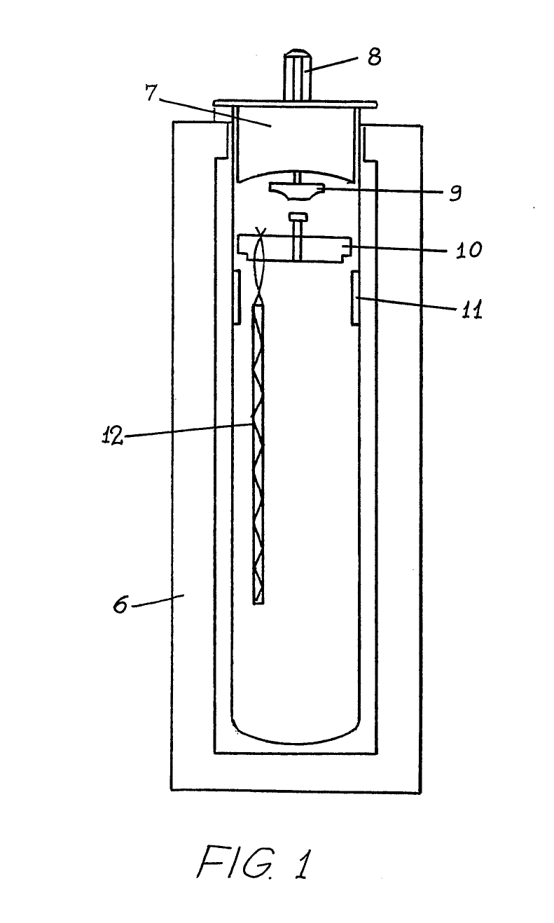

The state of the current technique is depicted in FIG. 1, which illustrates, in a schematic manner, a pit furnace of the conventional type, which is formed by a structure (6), which is closed by a lid (7), in which an engine is mounted (8), used for activating the air recirculator (helix) (9), and, the star-like support basis is mounted inside the furnace structure (10) itself.

In face of the state of the technique described above, the present Invention Patent of Pit Furnace Closing System is being proposed, which will be related with reference to the drawings listed below, in which:

FIG. 1 illustrates a schematic view of a pit furnace of the conventional type;

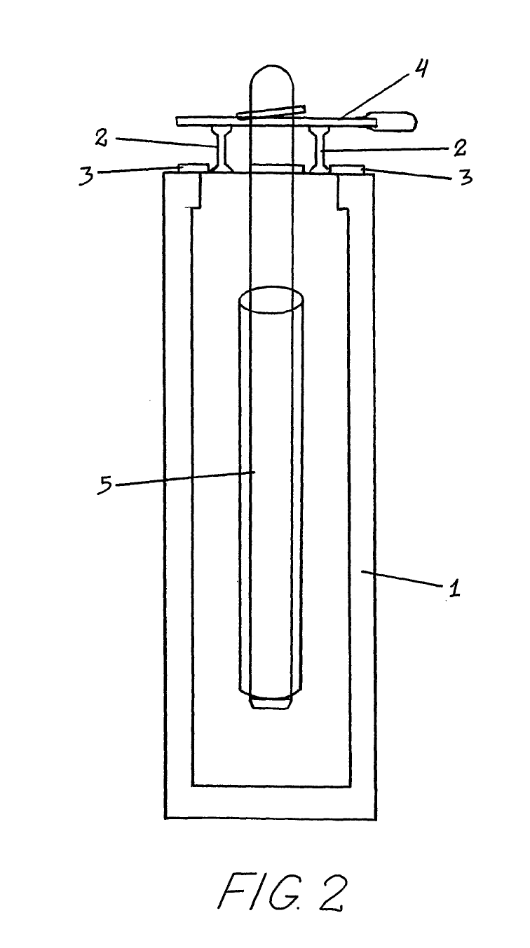

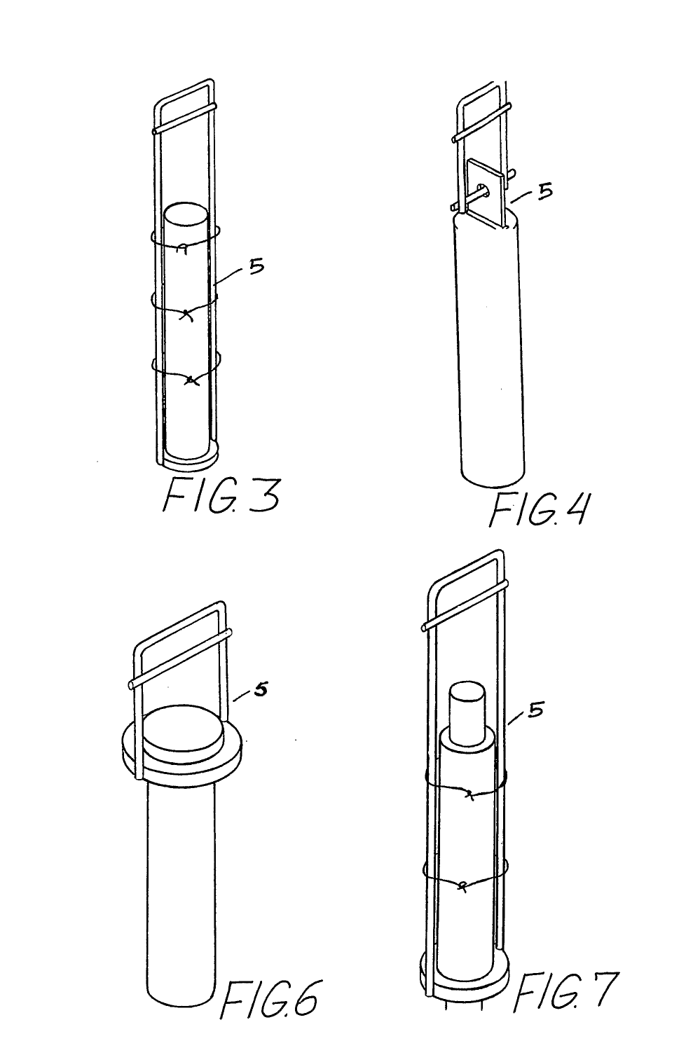

FIG. 2 illustrates an also schematic view, however, referring to the proposed pit furnace and its closing system;

FIGS. from 3 through 18 illustrate views of variants for the device that conditions the part to be worked on inside the pit furnace in reference; and

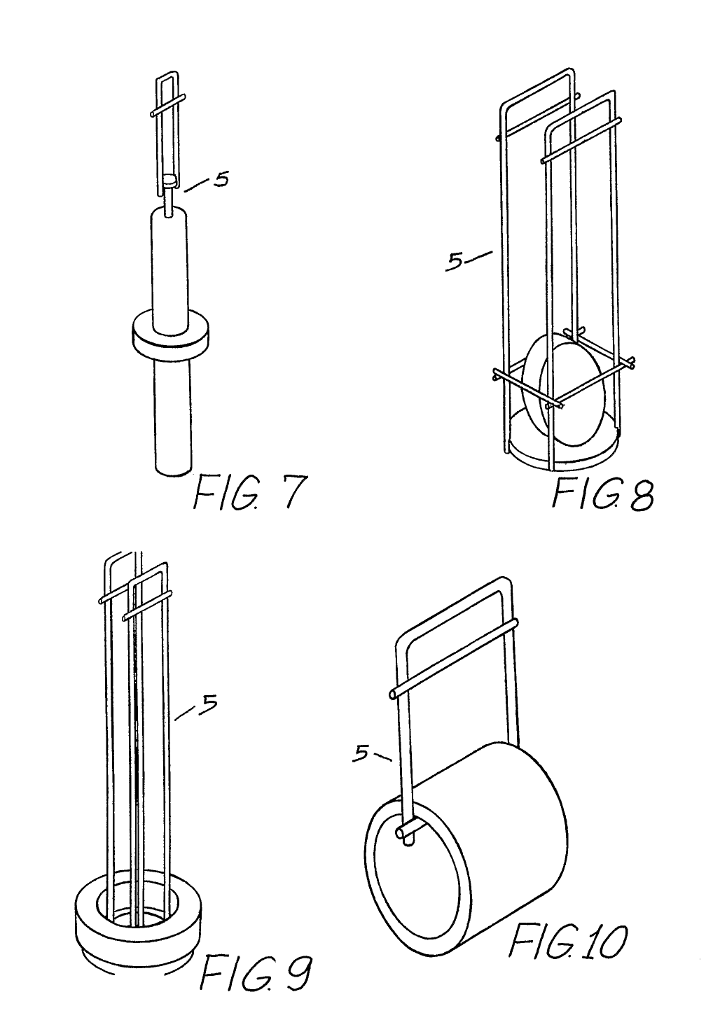

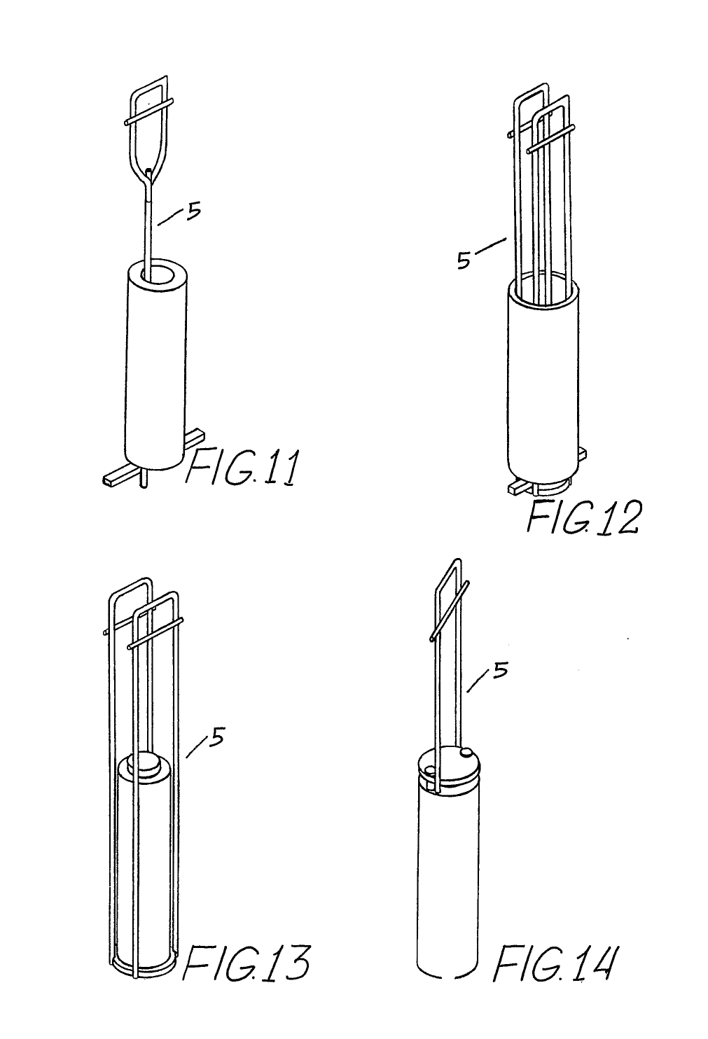

FIGS. 19, 20, 21, 21A, 22A, 23 and 23A represent variations of complementary lids for closing the pit furnace yet within the scope of this patent.

The conventional pit furnace with lid system, the structure of which is indicated by the reference 6 has a lid 7 that consists of a part similar to a cork, in the due proportions, that is, a lid made of A1020″ steel plate with coating of bricks, and the lower plate must be A310″ stainless steel, having linked an engine 8 to said lid for driving the helix 9, which is destined to promote the recirculation of the hot air inside the closed furnace.

The conventional pit furnace, as may be verified in FIG. 1, presents a more complex construction, as well as a more expensive one, further counting on a star-like support 10, which is mounted on a basis of said support indicated by the numerical reference 11.

In the system belonging to the state of the technique, the parts are always supported or hung in a basket-like device, similar to a tree, with a central axis having several beams, being said parts hung in these beams. This basket or tree may be supported on the floor of the furnace.

Also, with regards to the furnace closing system object of this present Invention Patent, a lid itself does not close the pit furnace 1, as in the conventional systems. For closing the pit furnace 1, two beams 2 are used, as well as A304* stainless steel square iron bars 4 having a diameter of 2 inches, laid across the border of the furnace structure 1 and supported over the beams 2.

Its construction is simple and its cost is very reduced in relation to the conventional furnaces, and its walls have a very reduced thickness in relation to the conventional pit furnace.

The closing means proposed by the present Invention Patent comprise the following: a) pieces of cloth wrap for high temperature are used for closing the furnace 3, cut in a manual way or with the use of a sharp blade; b) a species of box in a stainless steel screen was further developed, folded and having a ring, which is filled in with remains of wraps; c) another form used is a biparted lid in a thin plate with wraps fixed to it and a cut for the upper part of the supporting device of the parts to pass. This system is restricted so as to contain a single load, on the contrary of the other means, which allow for conditioning several parts in a same furnace.

In the present patent, the supports for the parts to be submitted to the high temperature are “cage”-like devices 5, which are suspended inside the furnace and supported in the two beams 2, not resting on the floor of the furnace, and several are the conditioning systems: a) the very light weighed parts may be fastened with a 3.2 mm wire approximately; b) the medium weighed and heavy parts will follow a table with the drawings of the more evident forms of conditioning; and c) other parts may be hung through welded rings in the parts themselves.

The pit furnace referred to herein has thermopairs, which may be in contact with the part entering into the mouth of the furnace, or may be loosen ones, and their heating ends are located in the central direction of each heating zone (thermopairs bar).

Yet with regards to the conventional system, this one allows protection gas to be used, and the surface is protected and the service may be performed on totally milled parts.

In the system object of the present invention, gas is not used; therefore, it is indicated to treat raw or previously milled parts; however, the advantages are numberless, mainly since it does not use refractory stainless steel baskets and, therefore, the operating cost is very reduced, generating the single means for making very large parts and very heavy ones, since they are hung in beams 2 external to the furnace 1 and for being not submitted to the heat, they are always cold and always resistant to support weight.

As a variant, a pit furnace is forecast having oil heating and having a rectangular format, which is coated with refractory bricks fixed with stainless steel pins. An end of the pin is welded in the plate of the furnace and the other part is welded in a square plate, which may contain a possible movimentation of the vertical walls of the furnace.

The burners may be fed with diesel oil or with viscous fuel oil. The conditioning of the parts and their being put inside the furnace are similar to the one already described with regards to the tubular pit furnace, as it is further similar to the closing system with cloth wraps for high temperature or with boxes having rings in stainless steel screen, folded, and wraps.

FIG. 19, 20, 21, 21A, 22, 22A, 23 and 23A represent variations of complementary lids for closing the pit furnace 1, as proposed.

The objective of the variations presented in the aforementioned figures is that of providing other options of closure through several forms of complementary lids, with constructive variations that offer the same technical advantages, both practical and functional, of the constructivity depicted in FIGS. from 2 through 18.

FIG. 19 depicts a variant in which the opening between the beams 2 is covered with wraps 3 and said wraps are supported over square A304″ stainless steel bars 4, having a diameter of 2 inches.

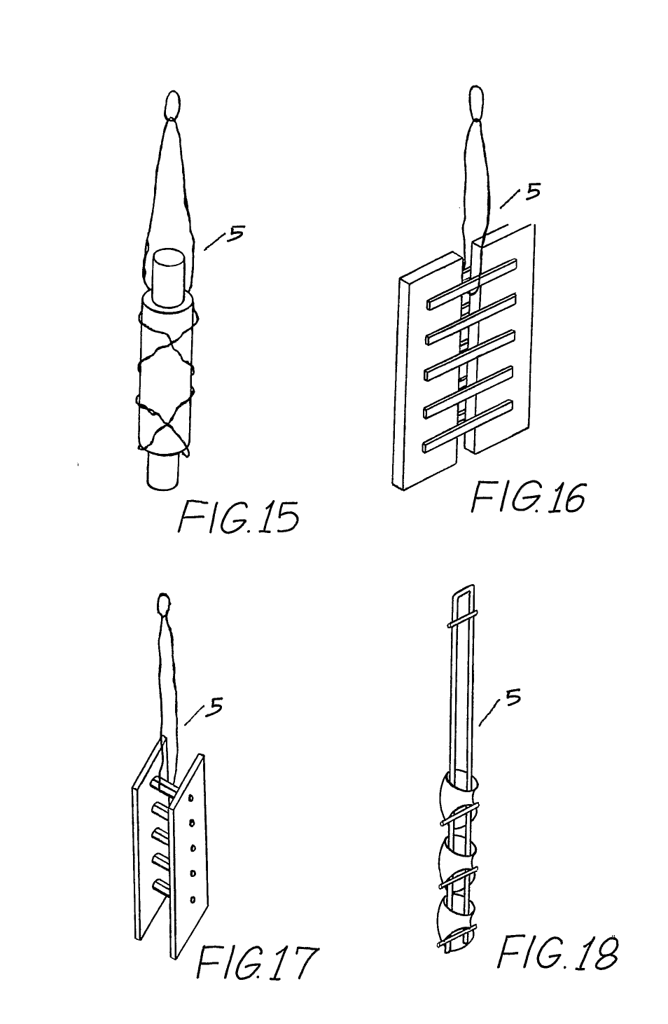

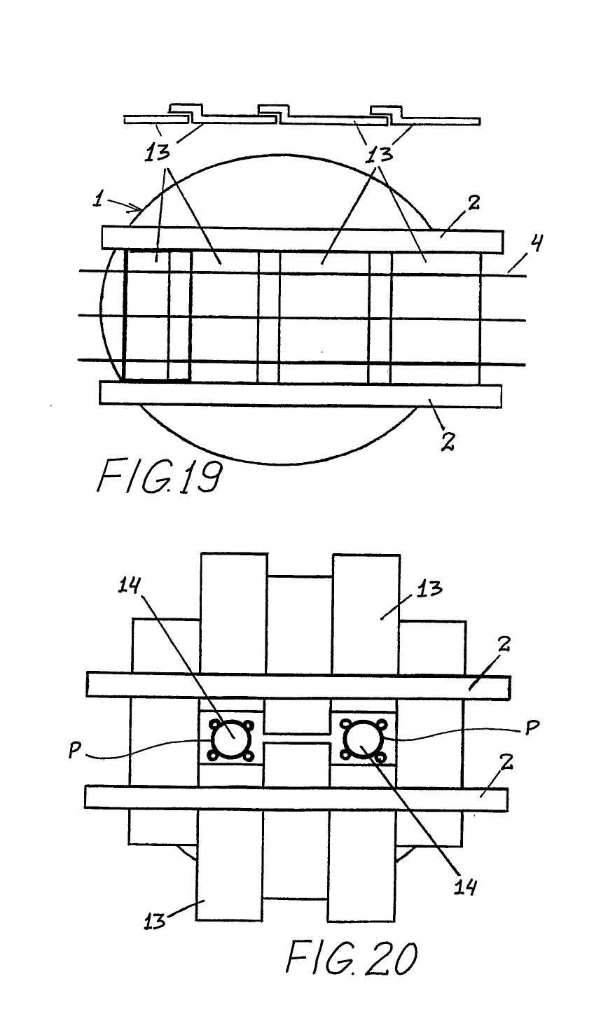

In FIG. 20, the fact that the opening between the beams 2 is closed with stainless steel coin screen plates 13 may be appreciated, filled in with wraps in flocks. It is observed that the plates touch each other when there is no device for supporting the parts 14, and when there is the device for supporting the parts, the plates get closer to each other at the maximum point, until they touch said device. All of the other openings are covered with wrap flocks or pieces of wrap.

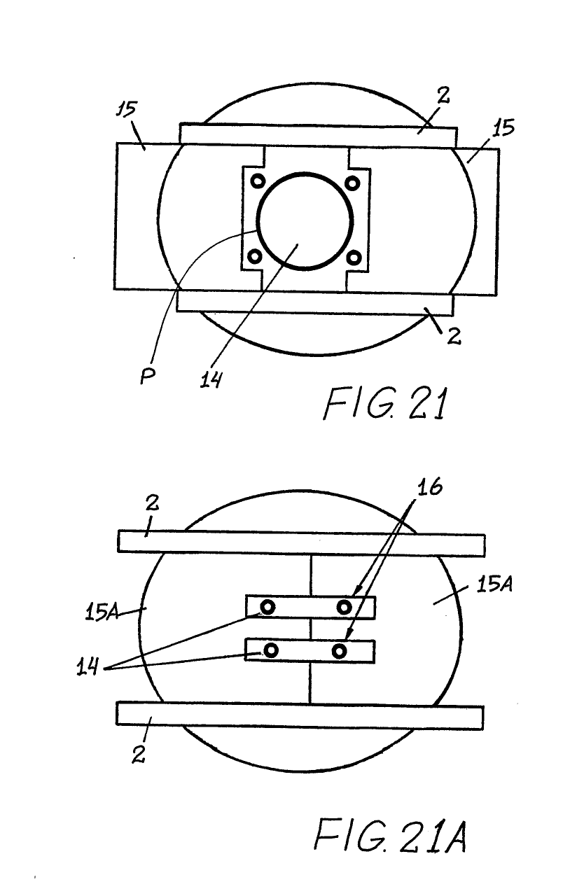

FIG. 21 depicts the fact that the lids are biparted 15 and touch each other when there is no load, and, when there is load, they touch the supporting device of the parts 14, leaving the device's internal space to be covered with wrap.

FIG. 21A depicts a variation of the lid of FIG. 21. The biparted lids, indicated in this case by reference 15, have a cut 16, which contributes for that there is a perfect mate with the bars of the device for supporting the parts 14.

The lids system of FIG. 21 is used for occasions in which only one device for supporting the parts will be put into the furnace, while the lid system of FIG. 21A serves for when the device for supporting the parts 14 have always the same dimensions.

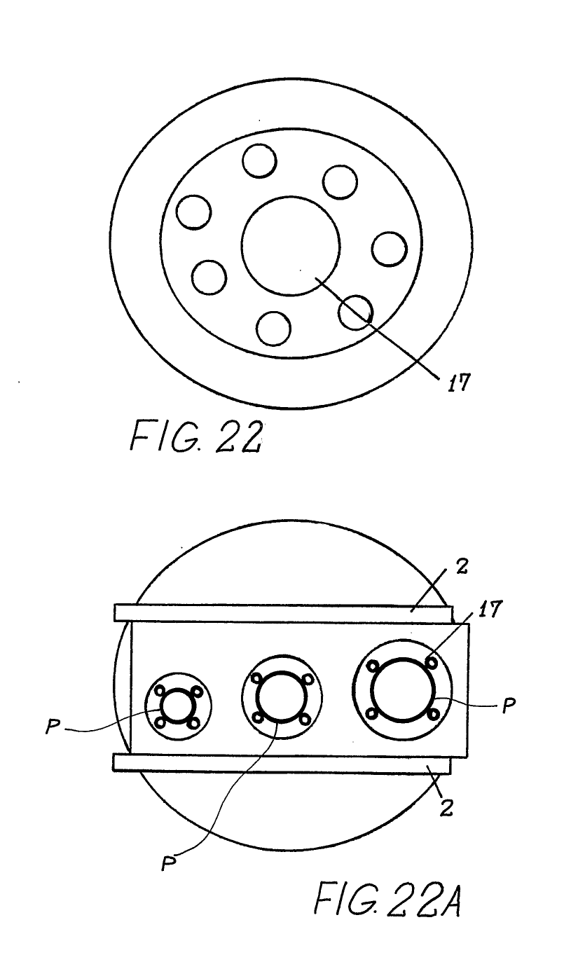

FIGS. 22 and 22A depict lids systems that are used in the situations in which thin and hung parts are put into the furnace without the device for supporting the parts, that is, when the parts are fastened to the ring by means of weld. After the part is removed, it is closed with lids with the same measures of the holes 17.

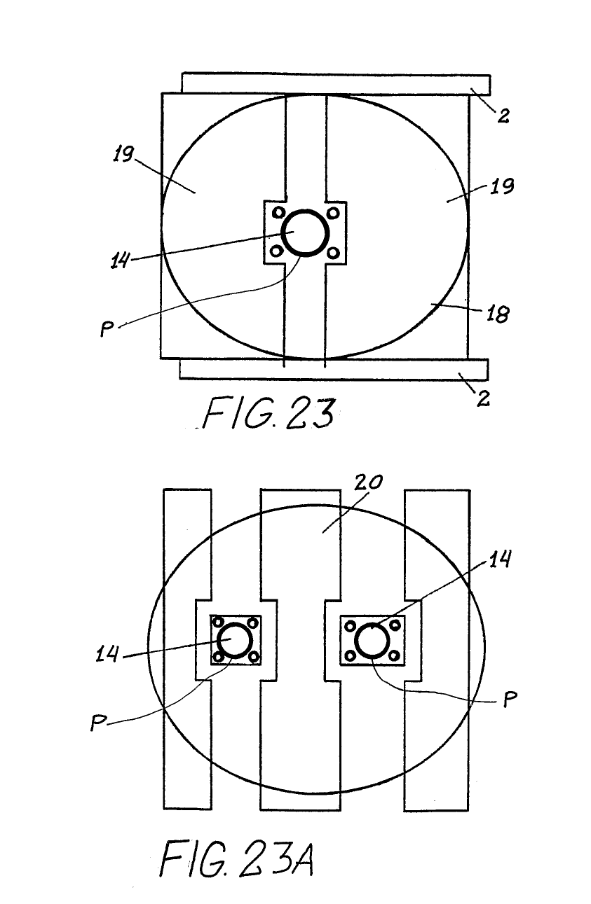

FIG. 23 depicts the fact that the beams 2 may be laid close to the internal diameter of the mouth 18 of the furnace. There will be, in this case, biparted doors 19 with rollers so as to aid with the displacements outwards or inwards. When the doors are closed, the device for supporting the parts 14 must have standard measures and a square plate so as to complete the closure.

FIG. 23A depicts the condition of the putting into the furnace being with two devices for supporting the parts, in which a plate 20 that is adapted between the two devices for supporting the parts 14 is foreseen.

In the several figures that illustrate the variations of complementary lids for closing the furnace 1, such as proposed, that is, in figures from 19 through 23A, the parts that are laid on the devices for supporting the parts 14 are indicated by reference P.

1. “PIT FURNACE CLOSING SYSTEM”, characterized by the fact that two beams are used (2), as well as A304* stainless steel square iron bars (4) laid across the border of the furnace structure (1) and supported over said beams, and, so as to close the furnace, pieces of cloth wrap for high temperature are used for closing the furnace (3), a species of box in a stainless steel screen was further developed, folded and having a ring, which is filled in with remains of wraps, and the other form used is a biparted lid in a thin plate with wraps fixed to it and a cut for the upper part of the supporting device of the parts to pass; and by the supports for the parts to be “cage”-like devices (5), which are suspended inside the furnace (1) supported in the two beams (2), not touching the floor of the furnace (2), and being several the conditioning systems.

2. “PIT FURNACE CLOSING SYSTEM”, according to claim 1, characterized by the fact that said pit furnace (1) has thermopairs that may be in contact with the part entering into the mouth of the furnace (1), or may be loosen ones, and their heating ends are located in the central direction of each heating zone (thermopairs bar).

3. “PIT FURNACE CLOSING SYSTEM”, according to claim 1, characterized by the fact that the pit furnace does not make use of gas and, therefore, to treat raw or previously milled parts, generating the single means for making very large parts and very heavy ones, since they are hung in beams (2) external to the furnace (1) and, which, for being not submitted to the heat, are always cold and always resistant to support weight.

4. “PIT FURNACE CLOSING SYSTEM”, according to claim 1, characterized by the fact that the pit furnace foresees a variant with oil heating and having a rectangular format, which is coated with refractory bricks fixed with stainless steel pins with an end of the pin is welded in the plate of the furnace and the other part is welded in a square plate, which may contain a possible movimentation of the vertical walls of the furnace. The burners may be fed with diesel oil or with viscous fuel oil.

5. “PIT FURNACE CLOSING SYSTEM”, according to claim 1, characterized by the fact that the opening between the beams (2) is covered with wraps (3) and said wraps are supported over square A304″ stainless steel bars (4), having a diameter of 2 inches.

6. “PIT FURNACE CLOSING SYSTEM”, according to claim 5, characterized by the fact that the opening between the beams (2) is closed with stainless steel coin screen plates (13) , filled in with wraps in flocks, and they are supported over square A304″ stainless steel bars (4), having a diameter of 2 inches, and the plates touch each other when there is no device for supporting the parts 14, and when there is the device for supporting the parts (14), and when there is the device for supporting the parts (14), said plates get closer to each other at the maximum point, until they touch said device. All of the other openings are covered with wrap flocks or pieces of wrap.

7. “PIT FURNACE CLOSING SYSTEM”, according to claim 5, characterized by the fact that the system in reference foresees biparted lids (15) that touch one another when there is no load, and, when there is load, they touch the supporting device of the parts (14), leaving the device's internal space to be covered with wrap, being a variation forecast in which the biparted lids (15A) have a cut (16) for mating with the bars of the device for supporting the parts (14).

8. “PIT FURNACE CLOSING SYSTEM”, according to claim 5, characterized by the fact that the lids have holes (17) and are used in the situations in which thin and hung parts are put into the furnace without the device for supporting the parts, that is, when the parts are fastened to the ring by means of weld, and, after the part is removed, it is closed with lids with the same measures of the holes (17).

9. “PIT FURNACE CLOSING SYSTEM”, according to claim 5, characterized by the fact that the beams (2) may be laid close to the internal diameter of the mouth (18) of the furnace. There will be, in this case, biparted doors (19) with rollers so as to aid with the displacements outwards or inwards. When the doors are closed, the device for supporting the parts (14) must have standard measures and a square plate so as to complete the closure; and in the case of the putting into the furnace being with two devices for supporting the parts (14), a plate (10) that is adapted between the two devices is foreseen.
